(19) United States
(12) Patent Application Publication
(10) Pub. No.: US 2006/0242362 A1
(43) Pub. Date: Oct. 26, 2006

(54) Method and apparatus for disconnecting an external data storage device from a computer

(76) Inventors: David H. Hanes, Loveland, CO (US); Alexandre P.V. Delorme, Grenoble (FR)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/111,181

(22) Filed: Apr. 20, 2005

(51) Int. Cl. G06F 12/00

(52) U.S. Cl. 711/115

(57) ABSTRACT

An apparatus for disconnecting an external data storage device from a computer. More specifically, there is provided an external data storage device comprising an activatable component to transmit a request to disconnect the external data storage device from a computer, wherein the activatable component comprises an apparatus capable of being physically or electrically activated.

### BACKGROUND

External data storage devices, such as external hard drives, allow a user to increase the available storage space on a computer without having to physically open a computer case and install a new disk drive. To utilize the external data storage device, the user connects a cable from the external data storage device to a connection point on the computer. Alternatively, a user can establish a wireless link between the external data storage device and the computer via a wireless protocol.

Modern operating systems implement a complex file management system to control data storage. These complex file management systems often include data caching algorithms that store copies of often used or recently used data files in the computer's memory because the computer's memory can be accessed much faster than disk drives. However, the system memory is smaller than the available storage on the disk drive. When the computer needs memory to store a file, the computer clears space in memory by running a file update routine to update the version of the file stored on the disk drive with the newer version stored in the computer's memory. Once the newest version of the file is stored on the disk drive, the computer can use the memory that was holding that file for another file. Even though the data caching algorithm described above dramatically improves the performance of a computer system, issues arise when external data storage devices are integrated into the computer's file system. These issues stem from the fact that external data storage devices are not permanently attached to the computer and can be easily removed. For instance, an external flash memory drive can be removed from a computer system by merely pulling the flash memory drive from its port. If a more recent copy of a data file from the external data storage device is stored in the computer system's memory instead of the external data storage device, data can be lost or corrupted if the external data storage device is unexpectedly disconnected from the computer. This loss or corruption of data occurs because there is no way for the operating system to update the data file on the external data storage device once the external data storage device is physically disconnected from the computer. Changes made to the copy of the data file that was being stored in the computer system's memory are lost.

Realizing that this potential data loss could be a problem, many computer operating systems have attempted to provide solutions that involve software that runs a file update routine to ensure that the most recent copy of the data file has been updated to the external data storage device. However, these file update routines need to be initiated by the user, and some users may not understand how to initiate the removal software.

### SUMMARY

Embodiments of the invention provide methods and apparatuses for disconnecting an external data storage device from a computer. Specifically, one embodiment of the invention comprises an external data storage device comprising an activatable component to transmit a request to disconnect the external data storage device from a computer, wherein the activatable component comprises an apparatus capable of being physically or electrically activated.

In another embodiment, there is provided a computer system comprising a computer and an external data storage device configured to send a signal to the computer when a user-activated component located on the external data storage device is activated, wherein the signal comprises a request to disconnect the external data storage device from the computer.

In yet another embodiment of the invention, there is provided a method of disconnecting an external data storage device comprising detecting the activation of an activatable component located on the external data storage device and generating a disconnection request after detecting the activation of the activatable component.

In yet another embodiment of the invention, there is provided a method comprising detecting the disconnection of an external data storage device from a computer system, notifying a user to reconnect the external data storage device, if the user reconnects the external data storage device, integrating the external data storage device into the computer system's file system, and running a file update routine between the computer and the external data storage device.

### BRIEF DESCRIPTION OF THE DRAWINGS

FIG. 1 is a block diagram of an exemplary computer system for disconnecting an external data storage device in accordance with embodiments of the invention;

FIG. 2 is a diagram of an exemplary external hard disk drive in accordance with embodiments of the present invention;

FIG. 3 is a diagram of an exemplary flash memory drive in accordance with exemplary embodiments of the present invention;

FIG. 4 is a flow chart illustrating an exemplary process for disconnecting an external data storage device in accordance with embodiments of the invention; and

FIG. 5 is a flow chart illustrating an exemplary process for preventing data loss due to disconnecting an external data storage device in accordance with embodiments of the invention.

### DETAILED DESCRIPTION

Exemplary embodiments in accordance with the present invention are directed towards an external data storage device, such as an external hard drive or a flash memory drive. The external data storage device includes an activatable component that transmits a request to disconnect the external data storage device. In one embodiment, this activatable component enables a user to remove the external data storage device without the risk of data loss or data corruption.

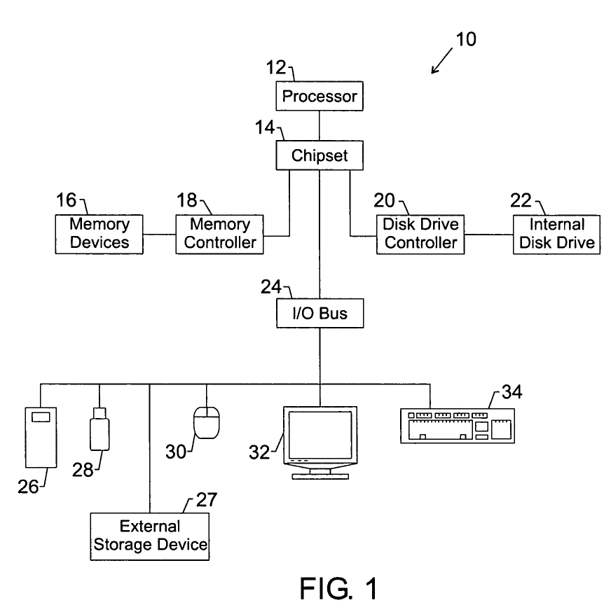

FIG. 1 shows a block diagram of an exemplary computer system 10 for disconnecting an external data storage device. In one embodiment, the computer system 10 includes one or more processors or central processing units (“CPUs”) 12. The CPU 12 is used individually or in combination with other CPUs. While the CPU 12 will be referred to primarily in the singular, a system with any suitable number of physical or logical CPUs can be implemented.

A chipset 14 is coupled to the CPU 12. The chipset 14 provides a communication pathway for signals between the CPU 12 and other components of the computer system 10 that includes a memory controller 18, an input/output (“I/O”) bus 24, and a disk drive controller 20. Depending on the configuration of the computer system 10, any one of a number of different signals could be transmitted through the chipset 14. The routing of the signals throughout the computer system 10 can be readily adjusted without changing the underlying nature of the computer system 10.

As shown, the memory controller 18 is operably coupled to the chipset 14. In alternate embodiments,,the memory controller 18 is integrated into the chipset 14. The memory controller 18 is operably coupled to one or more memory devices 16. In one embodiment, the memory devices 16 are any one of a number of industry standard memory types, including but not limited to, single inline memory modules (“SIMMs”) and dual inline memory modules (“DIMMs”). In certain embodiments of the invention, the memory devices 16 facilitate the safe removal of the external data storage devices by storing both instructions and data.

The chipset 14 is coupled to the I/O bus 24. The I/O bus 24 serves as a communication pathway for signals from the chipset 14 to I/O devices 26, 27, 28, 30, 32, and 34. The I/O devices 26, 27, 28, 30, 32, and 34 include external data storage devices, such as an external hard disk drive 26, an external data storage device 27, or a flash memory drive 28, as well as user interface devices, such as a mouse 30, a video display 32, or a keyboard 34. The external data storage device 27 may comprise any suitable type of external data storage device, such as a camera, a phone, or a memory card reader, that can be coupled to the computer system 10.

In one embodiment, the I/O bus 24 employs any one of a number of communications protocols to communicate with the I/O devices 26, 27, 28, 30, 32, and 34. External data storage devices communicate with the computer using an interface protocol. These interface protocols permit the computer to exchange information with the external data storage device. Acceptable communication protocols include, but are not limited to, universal serial bus (“USB”), USB-2, serial advanced technology attachment (“S-ATA”), IEEE-1394, small computer system interface (“SCSI”), integrated drive electronics (“IDE”), fiber channel, gigabit Ethernet, or Bluetooth. Various types of communication protocols can be implemented in the computer system 10. In one alternate embodiment, the I/O bus 24 is integrated into the chipset 14.

In one embodiment, the disk drive controller 20 is operably coupled to the chipset 14. The disk drive controller serves as the communication pathway between the chipset 14 and one or more internal disk drives 22. In certain embodiments of the invention, the internal disk drive 22 facilitates disconnection of the external data storage devices by storing both instructions and data. The disk drive controller 20 and the internal disk drives 22 communicate with each other or with the chipset 14 using any suitable type of communication protocol, including all of those mentioned above with regard to the I/O bus 24.

Embodiments in accordance with the present invention can be used in a wide variety of computer systems and electronic devices such as, but not limited to, cellular phones, personal computers, personal digital assistants, and other electronic devices that can be coupled to external data storage.

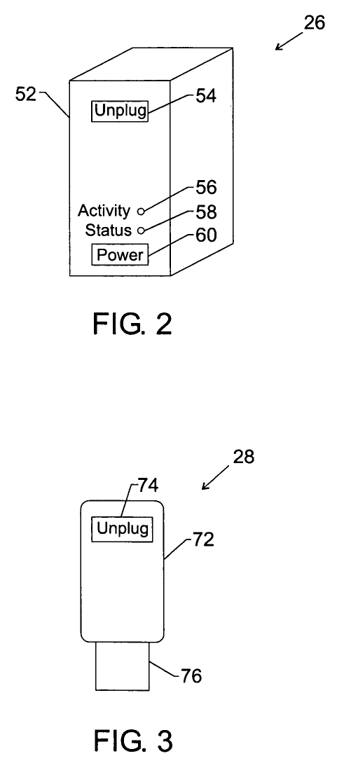

FIG. 2 shows an exemplary external hard disk drive 26 in accordance with embodiments of the present invention. The external hard disk drive 26 shown in FIG. 2 is a more detailed depiction of the external hard disk drive 26 previously described with regard to FIG. 1. In one embodiment, the external hard disk drive 26 includes a housing or case 52 that includes a disk drive unit (not shown), a power conversion circuit (not shown) to allow the external hard disk drive to be connected to a power source, and a communication protocol circuit (not shown) to permit the external hard disk drive 26 to communicate with the computer. The power circuitry and the communication circuitry can be located elsewhere without affecting the performance of the external hard disk drive 26.

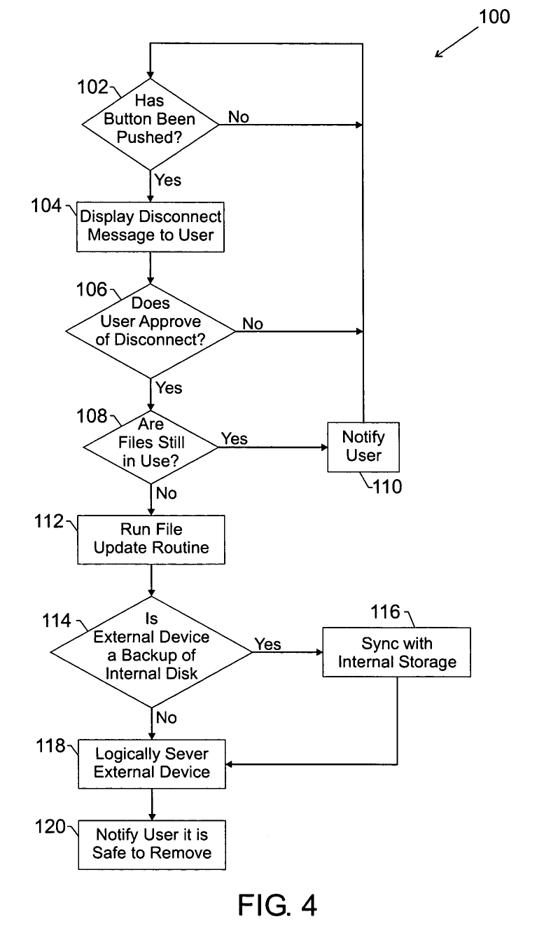

The external hard disk drive 26 also includes an activatable component 54. As used herein, an activatable component, such as the activatable component 54, includes, but is not limited to, an actuateable member, a push button, a switch, a touch sensitive pad, a surface that is able to activate when it detects a change in temperature or capacitance that accompanies a human's touch, or various other devices capable of being physically or electrically activated. The activatable component 54 may be located at a variety of suitable locations on the case 52 of the external hard disk drive 26. In one embodiment, when the user activates the activatable component 54, logic or software notifies the computer to which the external hard disk drive 26 is connected that the user wishes to disconnect the external hard disk drive 26. This process will be described in greater detail below in reference to FIG. 4. In one embodiment of the invention, the activatable component 54 has a distinctive color, such as red, to alert the user to its location. In another embodiment, the activatable component 54, flashes to alert the user to its location. In still another embodiment, the activatable component 54 may emit an audible alert to indicate its presence or location to the user.

In one embodiment, the external hard disk drive 26 also contains an activity light 56 and a status light 58. These lights inform the user about the activity level or status of the disk drive within the case 52. Lastly, the external hard disk drive 26 can contain a power switch 60. The power switch 60 allows the user to turn the external hard disk drive 26 either on or off. In alternate embodiments, the power switch 60 is not present, and power to the external hard disk drive 26 is controlled by manually connecting or disconnecting a power cord (not shown) to a power source.

FIG. 3 shows a flash memory drive 28 in accordance with exemplary embodiments of the present invention. The exemplary flash memory drive 28 shown in FIG. 3 is a more detailed depiction of the exemplary flash memory drive 28 previously described with regard to FIG. 1. In the illustrated embodiment, the flash memory drive 28 includes a case 72, an activatable component 74, and a connector 76. In one embodiment, the case 72 forms the body of the flash memory drive 28 and the flash memory drive 28 contains some form of solid state memory (not shown). In another embodiment, the case 72 contains a communication circuit (not shown) to permit the flash memory drive 28 to communicate with a computer by USB, USB-2, IEEE 1394, Bluetooth, or a similar communication protocol.

In one embodiment, the flash memory drive 28 also includes the connector 76. The connector 76 permits the flash memory drive 28 to physically connect to a computer. The size and shape of the connector 76 will vary based on the communication protocol employed by the flash memory drive 28. For example, if the flash memory drive 28 operates on a USB communication protocol, the connector 76 will be a USB plug. In another embodiment, where the flash memory drive 28 operates on a wireless communication protocol, such as Bluetooth or another suitable wireless communication protocol, the connector 76 is absent. In this case, a physical connection between the computer and the flash memory drive is not required, and thus the connector 76 is absent.

The flash memory drive 28 also includes the activatable component 74. The activatable component 74 is located at a variety of suitable locations on the flash memory drive 28. In one embodiment, when the user activates the activatable component 74, logic or software notifies the computer to which the flash memory drive 28 is connected that the user wishes to disconnect the flash memory drive 28. This process will be described in greater detail below in reference to FIG. 4. In one embodiment, the activatable component 74 has a distinctive color, such as red, to alert the user to its location. In another embodiment, the activatable component 74 flashes to alert the user to the location of the activatable component 74. In still another embodiment, the activatable component 74 may emit an audible alert to indicate its presence or location to the user.

FIG. 4 is a flow chart illustrating an exemplary process 100 for disconnecting an external data storage device in accordance with embodiments of the invention. While the process 100 will be described in terms of an unplug button, those skilled in the art will appreciate that another type of activatable component can be substituted for the unplug button. As indicated in block 102, the process 100 begins with a computer waiting for the unplug button to be activated on one of the external data storage devices. After the unplug button has been actuated (e.g., pressed), the external data storage device transmits or sends a disconnect request signal to a CPU or a chipset indicating that the unplug button has been activated. In one embodiment, once the disconnect request signal has been sent, the computer displays a disconnect message to the user on a display, as indicated by block 104. In one embodiment, this disconnect message confirms that the user wants to disconnect the external data storage device. In another embodiment, the computer will execute a software routine embedded within an operating system in response to the disconnection request signal. For example, if the computer is running the Windows operating system, the computer could run the safely remove hardware software feature. In alternate embodiments, the disconnect message is omitted.

Once the user confirms the request to unplug the external data storage device (block 106), the computer will determine if one or more of the files stored on the external data storage device are currently in use by the computer as indicated in block 108. In one embodiment, if the files are still in use, the computer notifies the user, as indicated in block 110, and gives the user the opportunity to close the file that is in use prior to disconnecting the external data storage device. In alternate embodiments, the computer automatically closes the files located on the external data storage device that are currently in use. In this case, the user notification shown in block 110 is not needed.

Next, per block 112, the computer runs a file update routine on the external data storage device. During the file update routine, the computer prepares the external data storage device to be disconnected from the computer. In one embodiment, this preparation involves checking the files stored on the external data storage device to ensure that changes made to a file that has been copied into the computer memory have been updated back to the copy of the file stored on the external data storage device. In one embodiment, the file update routine also includes the additional steps required to prepare or facilitate the external data storage device to be disconnected from the computer. In one alternate embodiment, the file update routine also includes removing the external data storage device from the computer's file system or adjusting the power to the external data storage device.

Per block 114, after the computer has run the file update routine (block 112), the computer determines if the external data storage device is functioning as a backup of one of the internal disk drives. In one embodiment, the external data storage devices are used as back-up storage for one of the internal disk drives. If the external data storage device is being used as a backup for one of the internal disk drives, the computer synchronizes pre-designated files stored on the internal disk drive with the external data storage device, as indicated in block 116. This synchronization process can take many forms and is well know to those skilled in the art. In alternate embodiments of the invention, the synchronization process takes place at some other point within the process 100.

Regardless of whether the external data storage device is being used as a backup, the computer logically severs the external data storage device from the computer if the external data storage device was not previously logically severed. In one embodiment, logically severing the external storage device comprises removing the external data storage device from a computer's file system, as indicated in block 118. In one embodiment, the computer will then notify the user that the user can now safely disconnect the external data storage device without risk of data loss, as illustrated in block 120. In one embodiment, this notification comprises displaying a message to the user indicating that it is safe to disconnect the external data storage device from the computer. In another embodiment, notifying the user may comprise illuminating a light or displaying a message on the external data storage device to indicate that it is safe to disconnect the external data storage device. In yet another embodiment, notifying the user may comprise an audible notification, such as a tone or a computerized voice.

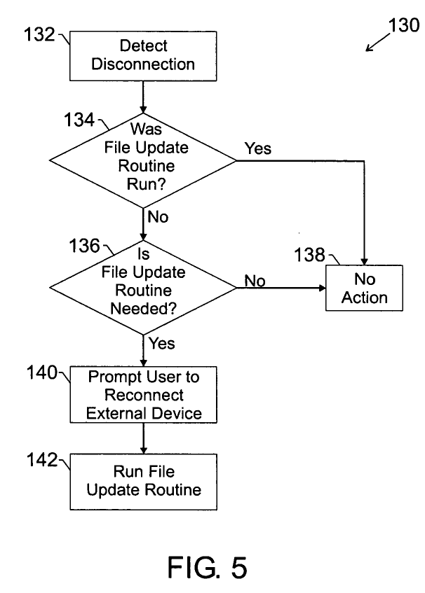

FIG. 5 is a flow chart illustrating an exemplary process 130 for preventing data loss due to disconnecting an external data storage device in accordance with embodiments of the invention. As stated above, disconnecting an external data storage device without executing a file update routine can result in file corruption or data loss. As indicated in block 132, the process 130 begins with the detection of a disconnection of an external data storage device. After detecting the disconnection, the process 130 continues by determining whether a file update routine was run for the disconnected external data storage device. In one embodiment, the process will determine if the file update routine was run prior to the disconnection of the external data storage device. If the file update routine was run, the process 130 ends, as indicated in block 138. If, however, the file update routine was not run for the external data storage device, the process 130 will determine whether the file update routine should be run for the disconnected external data storage device (i.e., are there any files in the computer memory that have non-updated copies on the external data storage device). If the file update routine did not need to be run, the process 130 ends as indicated in block 138. Those skilled in the art will appreciate that in alternate embodiments, blocks 134 and 136 can be swapped. In other words, in alternate embodiments, the process 130 first determines whether the file update routine needed to be run and then determines whether the file update routine was run.

If the file update routine should have been run prior to the disconnection of the external data storage device, the process 130 continues by prompting the user to reconnect the external data storage device, as indicated by block 140. Once the user reconnects the external data storage device, the process 130 concludes by executing the file update routine for the external data storage device, as indicated in block 142.

While the blocks outlined with regard to FIGS. 4 and 5 have been illustrated in the order discussed above, this order is merely exemplary. In alternate embodiments, the order of the blocks can be modified. Further, blocks may be added, deleted, modified, or rearranged and still be within embodiments in accordance with the present invention.

Many of the steps of the exemplary processes described above with reference to FIGS. 2, 3, 4, and 5 comprise an ordered listing of executable instructions for implementing logical functions. The ordered listing can be embodied in a computer-readable medium for use by or in connection with a computer-based system that can retrieve the instructions and execute them to carry out the previously described processes. In the context of this application, the computer-readable medium can be a means that can contain, store, communicate, propagate, transmit or transport the instructions. By way of example, the computer readable medium can be an electronic, a magnetic, an optical, an electromagnetic, or an infrared system, apparatus, or device. An illustrative, but non-exhaustive list of computer-readable mediums can include an electrical connection (electronic) having one or more wires, a portable computer diskette, a random access memory (RAM) a read-only memory (ROM), an erasable programmable read-only memory (EPROM or Flash memory), an optical fiber, and a portable compact disk read-only memory (CDROM). It is even possible to use paper or another suitable medium upon which the instructions are printed. For instance, the instructions can be electronically captured via optical scanning of the paper or other medium, then compiled, interpreted or otherwise processed in a suitable manner if necessary, and then stored in a computer memory.

What is claimed is:

1. An external data storage device comprising an activatable component to transmit a request to disconnect the external data storage device from a computer, wherein the activatable component comprises an apparatus capable of being physically or electrically activated.

2. The external data storage device, as set forth in claim 1, wherein the external data storage device comprises an external hard disk drive.

3. The external data storage device, as set forth in claim 1, wherein the external data storage device comprises a flash memory drive.

4. The external data storage device, as set forth in claim 1, wherein the external data storage device comprises one of the following: a camera, a phone, or a memory card reader.

5. The external data storage device, as set forth in claim 1, wherein the activatable component comprises a button or a switch on a housing of the external data storage device.

6. The external data storage device, as set forth in claim 1, wherein the activatable component comprises a touch or temperature sensitive pad.

7. The external data storage device, as set forth in claim 1, wherein the activatable component is electrically activated upon detecting a capacitance change.

8. A computer system comprising:
a computer; and
an external data storage device configured to send a signal to the computer when a user-activated component located on the data storage device is activated, wherein the signal comprises a request to disconnect the data storage device from the computer.

9. The computer system, as set forth in claim 8, wherein the external data storage device sends a request to activate a software routine to safely remove the external data storage device.

10. The computer system, as set forth in claim 8, wherein, the computer is configured to copy a file from a memory of the computer system to the external data storage device after the user-activated component is activated, wherein the file was previously copied from the external data storage device to the computer's memory.

11. The computer system, as set forth in claim 8, wherein the computer updates a file on the external data storage device if a copy of the file stored in a memory of the computer system does not match the file.

12. The computer system, as set forth in claim 8, wherein the computer logically severs a connection between the external data storage device and the computer after the user-activated component is activated.

13. The computer system, as set forth in claim 12, wherein the computer copies one or more pre-designated files to the external data storage device before logically severing the connection.

14. A method of disconnecting an external data storage device from a computer comprising:
detecting activation of an activatable component located on the external data storage device; and
transmitting a disconnection request from the external data storage device to the computer after detecting the activation of the activatable component.

15. The method, as set forth in claim 14, comprising automatically executing, upon detection of the disconnection request by the computer, a file update routine to copy a file stored on the external data storage device.

16. A tangible machine-readable medium, comprising:
code to detect activation of an activatable component located on an external data storage device;
code to determine if any files stored on the external data storage device are still in use by a computer;
code to notify a user if any files located on the external data storage device are still in use by the computer;
code to delay execution of a file update routine until no files stored on the external data storage device are still in use by the computer;
code to run the file update routine; and
code to logically sever the external data storage device from the computer.

17. The tangible medium, as set forth in claim 16, comprising:
code to determine if the external data storage device is configured as a backup of an internal disk drive; and
code to synchronize pre-designated files between the external data storage device and the internal disk drive if the external data storage device is configured as a backup of the internal disk drive.

18. A method comprising:
detecting disconnection of an external data storage device from a computer system;
notifying a user to reconnect the external data storage device;
if the user reconnects the external data storage device, integrating the external data storage device into a file system of the computer system; and
running a file update routine between the computer and the external data storage device.

19. The method, as set forth in claim 18, comprising:
determining if a file stored on the external data storage device has a copy stored in a memory of the computer;
determining if the copy stored in the memory matches the file stored on the external data storage device; and
running the file update routine if the copy stored in the memory does not match the copy stored on the external data storage device.

20. The method, as set forth in claim 19, comprising:
determining if a file update routine had been executed before the detection of the disconnection; and
running the file update routine if the file update routine was not executed before detecting the disconnection.

21. A computer system comprising:
an external data storage device; and
a computer removably connected to the external storage device and configured to:
detect disconnection of the external storage device from the computer;
prompt a user to reconnect the external data storage device to the computer; and
execute a file update routine between the computer and the external storage device if the external data storage device is reconnected to the computer.
